(19) United States
(12) Patent Application Publication
(10) Pub. No.: US 2025/0238665 A1
(43) Pub. Date: Jul. 24, 2025

(54) ELECTRONIC DEVICE FOR FINE-TUNING A MACHINE LEARNING MODEL AND METHOD OF OPERATING THE ELECTRONIC DEVICE

(71) Applicants: SAMSUNG ELECTRONICS CO., LTD., SUWON-SI (KR); IUCF-HYU (Industry-University Cooperation Foundation Hanyang University), Seoul (KR)

(72) Inventors: Jaehyung Ahn, Suwon-si (KR); Jungwook Choi, Seoul (KR); Minsoo Kim, Seoul (KR); Sihwa Lee, Seoul (KR)

(21) Appl. No.: 18/809,476

(22) Filed: Aug. 20, 2024

(30) Foreign Application Priority Data
Jan. 19, 2024 (KR) 10-2024-0008827

(51) Int. Cl. G06N 3/0495; G06N 3/08

(52) U.S. Cl. CPC G06N 3/0495; G06N 3/08

(57) ABSTRACT

An electronic device for fine-tuning a machine learning model and a method of operating the electronic device are provided. The electronic device includes at least one processor and a memory configured to store instructions executable by the at least one processor. When at least some of the instructions are executed by the at least one processor, the at least some of the instructions executed control the electronic device to determine a final weight of a current layer of a neural network by quantizing an addition result of combining a quantized base weight in low precision to an adapter weight in high precision, generate a product result based on the final weight and an activation input of the current layer, and transmit the multiplication result to a next layer of the neural network.

### CROSS-REFERENCE TO RELATED APPLICATION

This U.S. non-provisional patent application claims priority under 35 U.S.C. § 119 to Korean Patent Application No. 10-2024-0008827, filed on Jan. 19, 2024, in the Korean Intellectual Property Office, the disclosure of which is incorporated by reference herein in its entirety.

### BACKGROUND

One or more embodiments relate to an electronic device for fine-tuning a machine learning model and a method of operating the electronic device.

A machine learning model may be pre-trained with a large amount of pre-collected training data and then may be fine-tuned with corresponding training data for a specific task to be performed. When the size of the machine learning model is large, operation resources and memory resources for fine-tuning the machine learning model may be increased.

### SUMMARY

Embodiments of the present disclosure provide an electronic device including at least one processor and a memory configured to store instructions executable by the at least one processor. When at least some of the instructions are executed by the at least one processor, the at least some of the instructions executed control the electronic device to determine a final weight of a current layer of a neural network by quantizing an addition result of combining a quantized base weight in low precision to an adapter weight in high precision, where the quantized base weight is a base weight quantized from the neural network of a pre-trained machine learning model, generate a product result based on the final weight and an activation input of the current layer, and transmit the multiplication result to a next layer of the neural network.

Embodiments of the present disclosure provide a method of operating an electronic device, the method includes determining a final weight of a current layer of a neural network by quantizing an addition result of combining a quantized base weight in low precision to an adapter weight in high precision, where the quantized base weight is a base weight quantized from the neural network of a pre-trained machine learning model, generating a product result based on the final weight and an activation input of the current layer, and transmit the multiplication result to a next layer of the neural network.

Embodiments of the present disclosure provide a method including obtain a quantized base weight of a first layer of a neural network in low precision, generate an adapter weight in high precision based on the quantized base weight, generate a final weight in low precision based on the quantized base weight and the adapter weight, generate a multiplication result based on the final weight and an activation input, where the multiplication result is used as an input to a second layer of the neural network. The method further includes obtain a first gradient in the second layer, generate a second gradient of the final weight in the first layer based on the first gradient and the activation input in the first layer, compute a third gradient for the adapter weight based on the second gradient, and update the adapter weight of the first layer of the neural network based on the third gradient.

### BRIEF DESCRIPTION OF THE DRAWINGS

FIG. 1 is an example diagram for pre-training and fine-tuning a machine learning model according to an embodiment of the present disclosure.

FIG. 2 is an example diagram of a base weight and an adapter weight used in fine-tuning according to an embodiment of the present disclosure.

FIG. 3 is an example diagram of a forward propagation of fine-tuning according to an embodiment of the present disclosure.

FIG. 4 is an example diagram of back propagation of fine-tuning according to an embodiment of the present disclosure.

FIG. 5 is an example diagram of an electronic device according to an embodiment of the present disclosure.

FIG. 6 is an example of a method for operating an electronic device according to an embodiment of the present disclosure.

FIG. 7 is an example of a method for generating a multiplication result according to an embodiment of the present disclosure.

FIG. 8 is an example of a method for fine-tuning the adapter weight of a neural network according to an embodiment of the present disclosure.

### DETAILED DESCRIPTION

The following detailed structural or functional description is provided as an example and various alterations and/or modifications may be made to the embodiments. Accordingly, the embodiments are not construed as limited to the disclosure and should be understood to include all changes, equivalents, and replacements within the inventive concept and the technical scope of the disclosure.

As used herein, the phrases “A or B”, “at least one of A and B”, “at least one of A or B”, “A, B or C”, “at least one of A, B and C”, “at least one of A, B, or C”, and “one or a combination of at least two of A, B, and C,” each of which may include any one of the elements listed together in the corresponding one of the phrases, or all possible combinations thereof. Although terms, such as first, second, and the like are used to describe various components, the components are not limited to the terms. These terms should be used to distinguish one component from another component. For example, a first component may be referred to as a second component, and similarly the second component may be referred to as the first component.

In some cases, when a first component is described as being “connected”, “coupled”, or “joined” to a second component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments of the present disclosure are be described in detail with reference to the accompanying drawings. When describing the embodiments with reference to the accompanying drawings, like reference numerals refer to like components and a repeated description related thereto may be omitted.

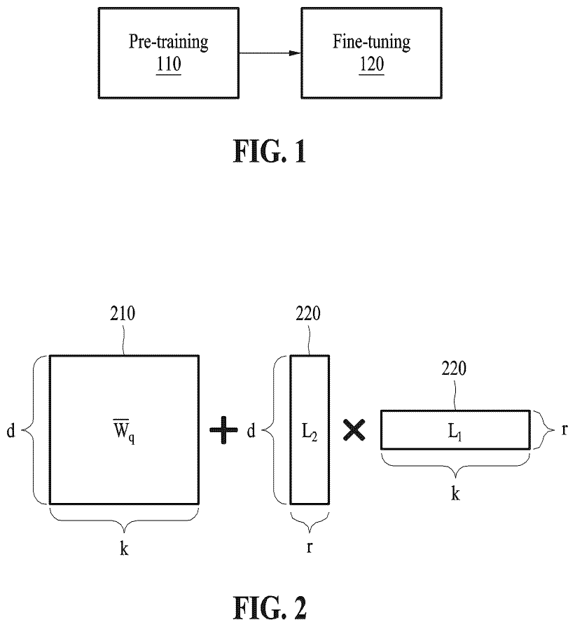

FIG. 1 is an example diagram for pre-training and fine-tuning a machine learning model according to an embodiment of the present disclosure. Referring to FIG. 1, a training process of the machine learning model may include pre-training 110 and fine-tuning 120.

A machine learning model may be a neural network including a plurality of layers. In some cases, the machine learning model may include an artificial neural network (ANN). According to an embodiment, the neural network may include an input layer, a plurality of hidden layers, and an output layer. Each of the layers includes a plurality of nodes, also called artificial neurons. In some cases, each node is a calculation unit having one or more inputs and an output, and the nodes may be connected to each other. A weight may be set for a connection between nodes, and the weight may be adjusted or modified. The weight amplifies, reduces, or maintains a relevant data value, thereby determining the degree of influence of the data value on the final result. Weighted inputs of nodes included in a previous layer may be input into each node included in the output layer. A process of inputting weighted data from a predetermined layer to the next layer is referred to as propagation. For example, the machine learning model may include a large language model (LLM), transformer-based large-scale vision transformers, and a multi-modal model, but embodiments are not necessarily limited thereto.

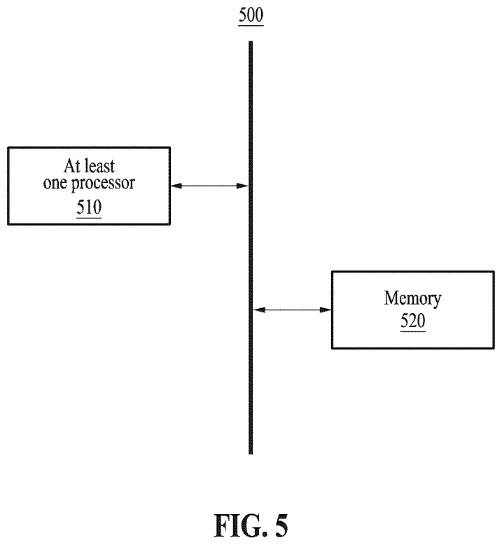

In some cases, a machine learning model is a computational algorithm, model, or system designed to recognize patterns, make predictions, or perform a specific task (for example, image processing) without being explicitly programmed. According to some aspects, the machine learning model is implemented as software stored in a memory unit (e.g., the memory 520 described with reference to FIG. 5) and executable by a processor unit (e.g., the at least one processor 510 described with reference to FIG. 5), as firmware, as one or more hardware circuits, or as a combination thereof.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

The pre-training 110 of the machine learning model may refer to a process of training the machine learning model with a large-scale dataset or a dataset corresponding to a specific task. During the pre-training 110, a parameter (e.g., a weight) of the machine learning model may be adjusted or modified.

The fine-tuning 120 of the machine learning model, which is parameter-efficient fine-tuning, may refer to a process of fine-tuning one or more model parameters based on a new task in the pre-trained machine learning model, instead of training a new machine learning model from the beginning for the new task. In addition to the weight determined in the pre-training 110, the fine-tuning 120 may be performed based on the final weight obtained from an additional weight. In the present specification, for ease of description, the weight determined in the pre-training 110 may be referred to as a base weight and the additional weight may be referred to as an adapter weight.

In the fine-tuning 120, the base weight may remain the same, and the adapter weight may be adjusted or modified. In addition, as described in detail below, the final weight may be determined by combining a quantized base weight of low precision, in which the base weight is quantized, and the adapter weight of high precision.

Through low-precision fine-tuning 120 of the machine learning model, the relatively large base weight may remain the same and the relatively small adapter weight may be adjusted or modified. Accordingly, the number of operations for fine-tuning 120 may be effectively reduced, operation speed may be improved, and memory overhead may be reduced. Further detail on fine-tuning 120 is described with reference to FIG. 2.

FIG. 2 is an example diagram of a base weight and an adapter weight used in fine-tuning according to an embodiment of the present disclosure. The example shown includes a quantized base weight 210 and an adapter weight 220.

Referring to FIG. 2, an adapter weight 220 may effectively reduce operational and memory costs required for fine-tuning the machine learning model and may be expressed as a product of two matrices L₁ and L₂. In some aspects, the dimension of each of the two matrices L₁ and L₂ may be smaller than the dimension of a quantized base weight 210. For example, each of the matrices L₁ and L₂ may be represented as lower rank, rather than the quantized base weight 210. The quantized base weight 210 may be a matrix that quantizes a value determined during a pre-training process. In some cases, quantizing a value may refer to reducing the precision of numbers that represents the model parameter. In some cases, quantized base weight 210 may be a frozen weight that remains constant (e.g., not adjusted or modified) during a fine-tuning process. During the fine-tuning process, the adapter weight 220 may be a trainable weight that may be adjusted or modified. For example, the quantized base weight 210 may be represented as W̅_{q}∈ [symbol] ^{d×k}, and the two matrices L₂ and L₁ of the adapter weight 220 may be represented as L₂ ∈ [symbol] ^{d×r}, L₁ ∈ [symbol] ^{r×k}, respectively. However, embodiments of the [symbol] disclosure are not necessarily limited to the example described above.

The initial value of the adapter weight 220 may be determined based on a difference between a base weight determined during the pre-training process and the quantized base weight 210 in which the base weight is quantized. For example, the initial value of the adapter weight 220 may be determined by approximating the difference between the base weight and the quantized base weight 210 to a low rank based on singular value decomposition (SVD). For example, the initial value of the adapter weight 220 may be represented as Equation 1 below:

$${\overline{W}}_{q} = Q ( {W}_{0} ) , \\ {W}_{0} = {\overline{W}}_{q} + Error \approx {\overline{W}}_{q} + {L}_{2} {L}_{1} , \\ where Error {\to }_{SVD} {L}_{2} {L}_{1} \qquad ( 1 )$$

where W₀ represents a pre-trained base weight, Q( ) represents a quantization operation, and W̅_{Q} represents the quantized base weight 210.

In some cases, SVD is a method for matrix factorization that decomposes a matrix into two or more matrices. SVD is used in machine learning task such as dimensionality reduction and matrix factorization. In some cases, calculating the full matrix (e.g., W̅_{q}) may be computationally expensive, and by reducing the full matrix into smaller matrices, computational resources can be reduced. For example, W̅_{q} may be a matrix of d by k. After performing SVD, two matrices may be used to represent W̅_{q}. For example, the first matrix may be L₂ having a dimension of d by r, and the second matrix may be L₁ having a dimension of r by k. In some cases, for example, when r equals to 1, L₂ and Lᵢ may be two vectors. In some cases, r may be an integer greater than 1.

Based on an error generated by the quantization of the base weight, the initial value of the adapter weight 220 may be determined as described below. For example, since the adapter weight 220 of high precision is adjusted or modified in the fine-tuning process, the error caused by the quantization may be reflected in a loss function. Accordingly, fine-tuning may be performed to reduce the error caused by the quantization.

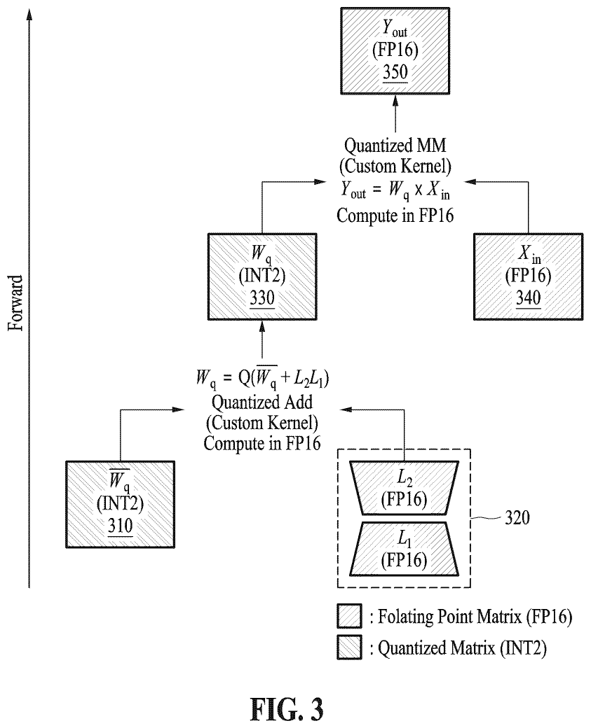

FIG. 3 is an example diagram of a forward propagation of fine-tuning according to an embodiment of the present disclosure. The example shown includes quantized base weight 310, adapter weight 320, final weight 330, activation input 340, and multiplication result 350.

Referring to FIG. 3, a forward propagation process during fine-tuning of a machine learning model is described. The forward propagation process described with reference to FIG. 3 may be shown based on a layer of a plurality of layers of the neural network of the machine learning model. For example, the forward propagation process may be performed on a layer, in which matrix multiplication is performed, among the plurality of layers. In FIG. 3, a floating point 16 (FP16) may represent high precision and an integer 2 (INT2) may represent low precision, but the examples of high precision and low precision are not necessarily limited thereto.

First, a final weight 330 of the layer may be determined based on a quantized base weight 310 in low precision and an adapter weight 320 in high precision. Since the precision of the quantized base weight 310 is different from the precision of the adapter weight 320, addition between the quantized base weight 310 and the adapter weight 320 may be performed based on mixed precision addition. In some cases, the addition operation may be performed at high precision, and an addition result may be quantized to low precision to generate the final weight 330. The operation in which the final weight 330 is determined may be represented in Equation 2:

$${W}_{q} = Q ( {\overline{W}}_{q} + {L}_{2} {L}_{1} ) \qquad ( 2 )$$

where W_{q} represents the final weight 330 in low precision. For example, by implementing the operation according to Equation 2 above as a custom kernel, the operation may be optimized, memory usage may be reduced, and operation speed may be effectively improved. In some cases, the kernel may represent one or more operations that are executed on an accelerator such as a graphics processing unit (GPU).

The final weight 330 in low precision may be multiplied by an activation input 340 having a high precision input to the layer, and a multiplication result 350 may be transmitted to an input of a next layer. Since the precision of the final weight 330 is different from the precision of the activation input 340, the multiplication between the final weight 330 and the activation input 340 may be performed based on mixed precision multiplication. Since the multiplication result 350 between the final weight 330 and the activation input 340 is transmitted to an input of a next layer, the error caused by quantization may be reflected in a loss function of the final training. Accordingly, fine-tuning may be performed to reduce the quantization error and to improve accuracy of the performance of a target task to be trained.

The multiplication result 350 is obtained by multiplying the final weight 330 in low precision and the activation input 340 in high precision as represented in Equation 3:

$${Y}_{out} = {W}_{q} \times {X}_{i n} \qquad ( 3 )$$

where Xᵢₙ represents the activation input 340 in high precision and Yₒᵤₜ represents the multiplication result 350 in high precision. For example, by implementing the operation according to Equation 3 above in the custom kernel, the operation may be optimized, memory usage may be reduced, and operation speed may be effectively improved.

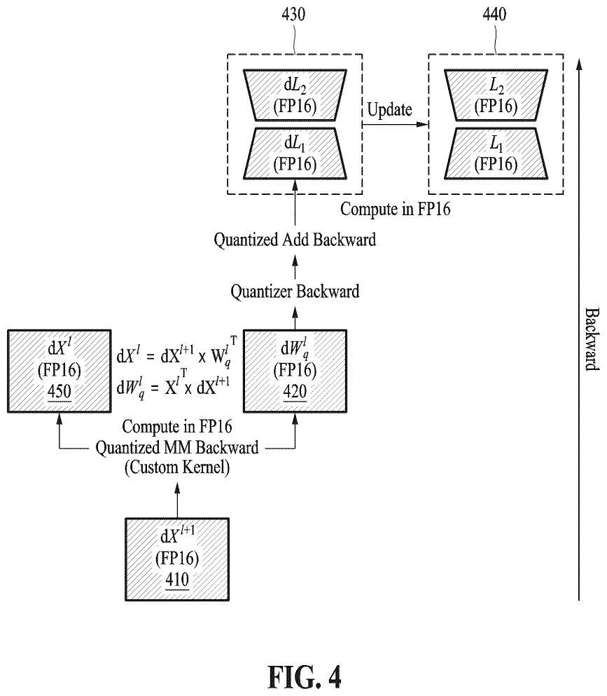

FIG. 4 is a diagram illustrating back propagation of fine tuning according to an embodiment. The example shown includes a first gradient 410, a second gradient 420, a third gradient 430, adapter weights 440, and a fourth gradient 450.

Referring to FIG. 4, a back propagation process during a fine-tuning process of a machine learning model is described. The back propagation process shown in FIG. 4 may be based on a layer of a plurality of layers of the neural network of the machine learning model. For example, the back propagation process may be performed on a layer, in which matrix multiplication is performed, among the plurality of layers.

According to some embodiments, a first gradient 410 transmitted from a next layer l+1 may be used to update adapter weights 440 of a current layer l. In some cases, the first gradient may be represented as dx^{l+1}. In some cases, adapter weights 440 includes weights for the two matrices, L₁ and L₂.

First, as shown in Equation 4 below, a second gradient 420 (e.g., dw_{q}^{l}) may be calculated:

$${dw}_{q}^{l} = {X}^{{l}^{T}} \times {dx}^{l + 1} \qquad ( 4 )$$

where the second gradient 420 represents a gradient of the final weight, where l represents the current layer, which is the l-th layer. In some cases, X¹^{^{T}} represents a transposed matrix of an activation input of the l-th layer. For example, by implementing the operation according to Equation 4 above as a custom kernel, the operation may be optimized, memory usage may be reduced, and the operation speed may be effectively improved.

By performing a quantizer backward and a quantized add backward for the second gradient 420, the third gradient 430 for the two matrices L₁ and L₂ may be calculated. By adjusting L₁ and L₂ based on the third gradient 430, the adapter weights 440 of the two matrices L₁ and L₂ may be updated. In some cases, the third gradient 430 may include a first matrix gradient dl₁ and a second matrix gradient dl₂.

In some cases, for example, the backward quantizer may be performed based on a straight through estimator (STE). Since a quantizer is a function that cannot be differentiated, a back propagation operation might not be possible. The backward quantizer may utilize the STE to generally allow the gradient to pass through.

For example, in quantized neural networks, weights and activations may be constrained to discrete values. However, discrete operations induce non-differentiable functions. In some cases, STE enables gradient-based optimization that includes non-differentiable quantization steps. For example, STE approximates the gradient as if the quantization functions were the identity functions, which allows the gradients to flow through. In some cases, STE allows the neural network to continue updating weights using gradient-based optimization techniques.

The quantized add backward performed in the back propagation process may calculate the gradient of the adapter weights 440 through dL₁=dW_{q}^{l}×L₂^{T} and dL₂=L₁×dW_{q}^{l}. This process may be a result of the mixed precision addition performed when determining the final weight during the forward propagation.

In some embodiments, a fourth gradient 450 (e.g., dX^{l}) to be transmitted to a previous layer l−1 may be calculated by the Equation 5 below:

$${dX}^{l} = {dX}^{l + 1} \times {W}_{q}^{{l}^{T}} \qquad ( 5 )$$

where W_{q}^{l}^{^{T}} represents a transposed matrix for the final weight of the l-th layer.

A process of calculating the second gradient 420 and the fourth gradient 450 from the first gradient 410 may be performed based on quantized matrix multiplication (MM) backward and may also be implemented in the custom kernel. To calculate the second gradient 420, a final weight W_{q}^{l} in low precision may be used. Accordingly, mixed precision multiplication may be performed during the back propagation process in the custom kernel.

After the adapter weights have been trained through the fine-tuning process described above, data inference may be performed through the machine learning model including the base weight and the adapter weight. The data inference may include, for example, pattern recognition (e.g., object recognition, face identification, etc.), sequence recognition (e.g., speech, gesture, handwritten texture recognition, machine translation, machine interpretation, etc.), control (e.g., vehicle control, process control, etc.), recommendation services, decision making, medical diagnosis, financial applications, data mining, and the like. However, the examples of data inference are not necessarily limited thereto.

The weight used for data inference may be determined and stored in a memory. For example, an addition result of the base weight and the adapter weight may be stored in the memory with high precision. In some embodiments, the addition result of the base weight and the adapter weight may be stored in the memory with low precision. In some embodiments, the base weight and the adapter weight may be stored separately in a memory and the addition of the base weight and the adapter weight may be performed during inference time.

FIG. 5 is an example diagram of an electronic device according to an embodiment of the present disclosure. The example, shown includes electronic device 500, at least one processor 510, and memory 520. In some cases, the electronic device includes a machine learning model.

Referring to FIG. 5, an electronic device 500 may include at least one processor 510 and a memory 520. The electronic device 500 may include, for example, various computing devices, such as a mobile phone, a smartphone, a tablet personal computer (PC), an e-book device, a laptop, a PC, a desktop, a workstation, or a server. In some cases, the electronic device 500 may include various wearable devices, such as a smart watch, smart eyeglasses, a head-mounted display (HMD), or smart clothing. In some cases, the electronic device 500 may include various home appliances, such as a smart speaker, a smart television (TV), or a smart refrigerator. In some cases, the electronic device 500 may include other devices, such as a smart vehicle, a smart kiosk, an Internet of things (IoT) device, a walking assist device (WAD), a drone, or a robot.

The at least one processor 510 may be a device that executes instructions or programs. In some cases, the at least one processor 510 may be a device that controls the electronic device 500. In some cases, the at least one processor 510 may include, for example, a GPU, a neural processing unit (NPU), a tensor processing unit (TPU), and the like. In some embodiments, the at least one processor 510 may include a central processing unit (CPU).

The memory 520 may store computer-readable instructions. The at least one processor 510 may include at least some of the instructions, when executed, cause the at least one processor 510 to perform various functions described herein. The memory 520 may be a volatile memory or a non-volatile memory.

The electronic device 500 may quantize an addition result of a quantized base weight of low precision and an adapter weight of high precision to determine the final weight of a current layer of the neural network. In some cases, the quantized base weight may be a quantized base weight of a pre-trained machine learning model. In some cases, the electronic device 500 may transmit, to a subsequent layer of the neural network, a result of product between the final weight and an activation input of the current layer.

The initial value of the adapter weight may be determined based on a difference between the base weight and the quantized base weight. The initial value of the adapter weight may be determined by approximating the difference to a low rank using SVD. The adapter weight may be expressed as a product of two matrices each having a dimension smaller than the dimension of the quantized base weight.

The final weight may be determined by a kernel executable by the at least one processor 510. The operation of multiplying the final weight and the activation input may be performed by a kernel executable by the at least one processor 510.

The adapter weight may be updated in a fine-tuning process of the machine learning model. In some embodiments, the base weight may be frozen during the fine-tuning process. The addition result of the quantized base weight and the adapter weight may be determined based on a mixed precision addition between the quantized base weight and the adapter weight. The final weight and the result of multiplication operation may be determined based on a mixed precision multiplication between the final weight and the activation input.

The adapter weight may be set for a layer, in which MM is performed, among a plurality of layers in the machine learning model. In some cases, the electronic device 500 may process the operations described above.

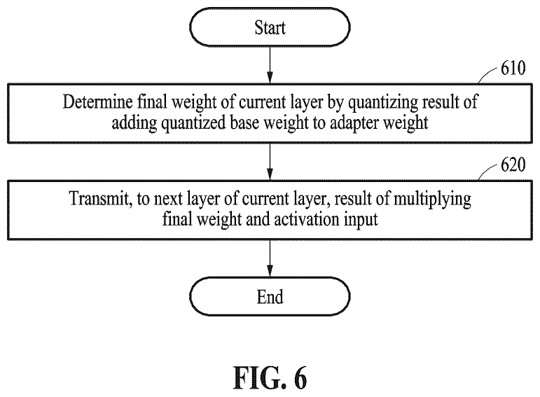

FIG. 6 is an example of a method for operating an electronic device according to an embodiment of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In the following embodiments, operations may be performed sequentially but not necessarily. For example, the order of the operations may change and at least two of the operations may be performed in parallel. Operation 610 and operation 620 may be performed by at least one component (e.g., a processor) of an electronic device (e.g., the electronic device described with reference to FIG. 5).

At operation 610, the electronic device may determine the final weight of a current layer by quantizing a result of adding a quantized base weight to an adapter weight. In some cases, the quantized base weight may have low precision. In some cases, the quantized base weight is a quantized base weight of a pre-trained machine learning model. In some cases, the adapter may have high precision.

At operation 620, the electronic device may transmit, to a next layer of the current layer, a result of multiplying the final weight and an activation input to the current layer. The descriptions provided with reference to FIGS. 1 to 5 may apply to the operations shown in FIG. 6, and thus a further detailed description thereof is omitted.

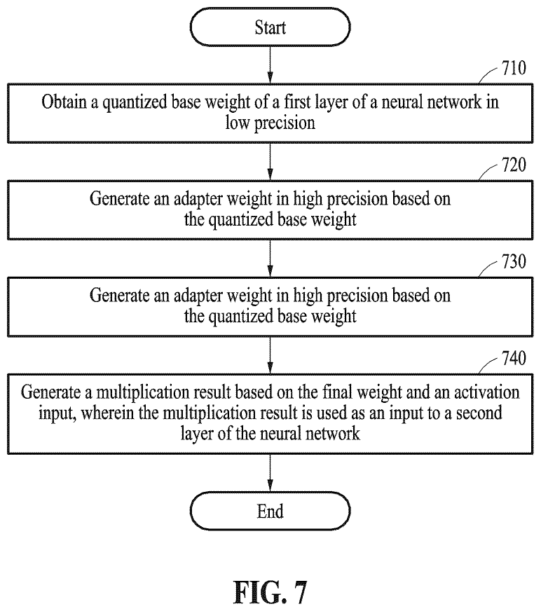

FIG. 7 is an example of a method for generating a multiplication result according to an embodiment of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 710, the system obtains a quantized base weight of a first layer of a neural network in low precision. At operation 720, the system generates an adapter weight in high precision based on the quantized base weight. At operation 730, the system generates a final weight in low precision based on the quantized base weight and the adapter weight. At operation 740, the system generates a multiplication result based on the final weight and an activation input, wherein the multiplication result is used as an input to a second layer of the neural network. The descriptions provided with reference to FIGS. 1 to 5 may apply to the operations shown in FIG. 7, and thus a further detailed description thereof is omitted.

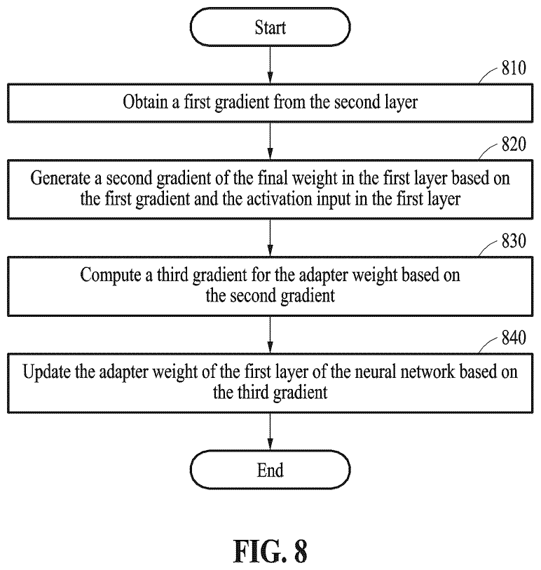

FIG. 8 is an example of a method for fine-tuning the adapter weight of a neural network according to an embodiment of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 810, the system obtains a first gradient in the second layer. At operation 820, the system generates a second gradient of the final weight in the first layer based on the first gradient and the activation input in the first layer. At operation 830, the system computes a third gradient for the adapter weight based on the second gradient. At operation 840, the system updates the adapter weight of the first layer of the neural network based on the third gradient. The descriptions provided with reference to FIGS. 1 to 5 may apply to the operations shown in FIG. 8, and thus a further detailed description thereof is omitted.

The embodiments described herein may be implemented using a hardware component, a software component, or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specifically designed and constructed for the purposes of embodiments, or program instructions may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter. The above-described hardware devices may be configured to act as one or more software modules in order to perform the operations of the above-described embodiments, or vice versa.

As described above, although the embodiments have been described with reference to the drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and equivalents to the claims are also within the scope of the following claims.

What is claimed is:

1. An electronic device comprising:
at least one processor; and
a memory configured to store instructions executable by the at least one processor,
wherein, when at least some of the instructions are executed by the at least one processor, the at least some of the instructions executed control the electronic device to:
determine a final weight of a current layer of a neural network by quantizing an addition result of combining a quantized base weight in low precision to an adapter weight in high precision, wherein the quantized base weight is a base weight quantized from the neural network of a pre-trained machine learning model;
generate a product result based on the final weight and an activation input of the current layer; and
transmit the product result to a next layer of the neural network.

2. The electronic device of claim 1, wherein:
an initial value of the adapter weight is determined based on a difference between the base weight and the quantized base weight.

3. The electronic device of claim 2, wherein:
the initial value of the adapter weight is determined by approximating the difference to a low rank based on singular value decomposition (SVD).

4. The electronic device of claim 1, wherein:
the adapter weight is expressed as a product of two matrices each having a dimension smaller than a dimension of the quantized base weight.

5. The electronic device of claim 1, wherein the at least some of the instructions executed control the electronic device to further:
update parameters of the adapter weight based on the product result.

6. The electronic device of claim 1, wherein:
the base weight is frozen while fine-tuning the adapter weight.

7. The electronic device of claim 1, wherein:
the addition result is determined based on the quantized base weight and the adapter weight using mixed precision addition.

8. The electronic device of claim 1, wherein:
the product result is determined based on the final weight and the activation input using mixed precision multiplication.

9. The electronic device of claim 1, wherein:
the adapter weight is set for a layer, in which matrix multiplication is performed, among a plurality of layers.

10. A method of operating an electronic device, the method comprising:
determining a final weight of a current layer of a neural network by quantizing an addition result of combining a quantized base weight in low precision to an adapter weight in high precision, wherein the quantized base weight is a base weight quantized from the neural network of a pre-trained machine learning model;
generating a product result based on the final weight and an activation input of the current layer; and
transmit the product result to a next layer of the neural network.

11. The method of claim 10, wherein:
an initial value of the adapter weight is determined based on a difference between the base weight and the quantized base weight.

12. The method of claim 11, wherein:
the initial value of the adapter weight is determined by approximating the difference to a low rank based on singular value decomposition (SVD).

13. The method of claim 10, wherein:
the adapter weight is expressed as a product of two matrices each having a dimension smaller than a dimension of the quantized base weight.

14. The method of claim 10, further comprising:
update parameters of the adapter weight based on the product result.

15. The method of claim 10, wherein:
the base weight is frozen while fine-tuning the adapter weight.

16. The method of claim 10, wherein:
the addition result is determined based on the quantized base weight and the adapter weight using mixed precision addition.

17. The method of claim 10, wherein:
the product result is determined based on the final weight and the activation input using mixed precision multiplication.

18. A method for fine-tuning a neural network of a machine learning model, comprising:
obtaining a quantized base weight of a first layer of a neural network in low precision;
generating an adapter weight in high precision based on the quantized base weight;
generating a final weight in low precision based on the quantized base weight and the adapter weight;
generating a multiplication result based on the final weight and an activation input, wherein the multiplication result is used as an input to a second layer of the neural network;
obtaining a first gradient in the second layer;
generating a second gradient of the final weight in the first layer based on the first gradient and the activation input in the first layer;
computing a third gradient for the adapter weight based on the second gradient; and
updating the adapter weight of the first layer of the neural network based on the third gradient.

19. The method of claim 18, further comprising:
determining an initial value of the adapter weight based on a difference between a base weight and the quantized base weight.

20. The method of claim 19, wherein:
the initial value of the adapter weight is determined by approximating the difference to a low rank based on singular value decomposition (SVD).
